(19) United States
(12) Patent Application Publication
(10) Pub. No.: US 2018/0124599 A1
(43) Pub. Date: May 3, 2018

(54) AUTHENTICATION FOR A LIMITED DATA ENTRY DEVICE

(71) Applicant: Microsoft Technology Licensing, LLC, Redmond, WA (US)

(72) Inventors: Brandon Werner, Redmond, WA (US); Adrian Frei, Seattle, WA (US)

(21) Appl. No.: 15/342,084

(22) Filed: Nov. 2, 2016

(51) Int. Cl. H04W 12/06; H04L 29/06; G06K 19/06; A63F 13/80; A63F 13/71; A63F 13/73

(52) U.S. Cl. CPC H04W 12/06; H04L 63/0876; G06K 19/06037; A63F 2300/8082; A63F 13/80; A63F 13/71; A63F 13/73; G06K 19/06112

(57) ABSTRACT

An LDE authentication system is provided for granting to an LDE device access to a resource of a resource provider. In accordance with the LDE authentication system, an LDE device sends to the resource provider a request to access the resource. The LDE device receives an indication sent by the resource provider to authenticate the resource provider using an identity provider. A non-LDE device sends to the identity provider credentials for use in authentication and receives an authentication code sent by the identity provider that indicates successful authentication by the identity provider. The LDE device receives the authentication code that was received by the non-LDE device. The LDE device sends to the identity provider the authentication code and receives an authentication token sent by the identity provider in response to receiving the authentication code. The LDE device sends to the resource provider the authentication token and accesses the resource.

### BACKGROUND

Many devices that are connected via a network have limited data entry (“LDE”) capabilities. These LDE devices may not have a physical keyboard and may have a user interface that makes it difficult for a user to provide some types of data entry. For example, visual headsets, such as virtual reality headsets and augmented reality headsets, typically do not have an associated physical keyboard. So, to input textual data, visual headsets typically display a virtual keyboard on the display of the virtual headset, thus presenting a 2D virtual keyboard in a 3D environment. The user can then look at a desired key on the virtual keyboard and click a button on the visual headset to select that key. The entry of passwords via a visual headset is especially difficult because passwords typically have many characters and may include uppercase and lowercase letters, numbers, and special characters. The entry is also difficult because only parts of a virtual keyboard may be displayed at a time, forcing the user to “scroll” to find the next key. For example, to enter a password such as “Pass$123word,” the user may need to select uppercase, select “P,” select lowercase, select “a,” “s,” and “s,” scroll to special characters, select “$,” and so on.

The authentication of a user is thus difficult when only one authentication factor, such as a password, is required to prove the user's identity, but it is even more difficult when multiple authentication factors are required. For example, an identity provider may employ a two-factor authentication to authenticate a user. The first authentication factor may be a password. The second authentication factor may be a one-time code that the identity provider sends to the user's smartphone during the authentication process or may be a one-time code generated by a security token, which may be a physical token or a software token. The entry of both the password and the one-time code makes the authentication process both more difficult and more time-consuming when using an LDE device.

Some visual headsets have a smartphone that provides both the display and the computer for the visual headset. As an alternative to entering the authentication factors via a virtual keyboard, these visual headsets may allow the user to remove the visual headset from their head, remove the smartphone from the visual headset, manually enter the authentication factors on a virtual keyboard of the smartphone, re-insert the smartphone in the visual headset, place the visual headset on their head, and resume interacting in the 3D environment. The process of removing the smartphone and later re-inserting the smartphone can lead to the user inadvertently touching the display, which can cause the smartphone to enter an unwanted state such as closing the current application, selecting an option of the application unrelated to authentication, dismissing the current content of the display, and so on. The process of removing and re-inserting the smartphone, even without the user inadvertently touching the display, is a less than desirable user experience.

### SUMMARY

An LDE authentication system is provided for granting to an LDE device access to a resource of a resource provider. In accordance with the LDE authentication system, an LDE device sends to the resource provider a request to access the resource. The LDE device receives an indication sent by the resource provider to authenticate the resource provider using an identity provider. A non-LDE device sends to the identity provider credentials for use in authentication and receives an authentication code sent by the identity provider that indicates successful authentication by the identity provider. The LDE device receives the authentication code that was received by the non-LDE device. The LDE device sends to the identity provider the authentication code and receives an authentication token sent by the identity provider in response to receiving the authentication code. The LDE device sends to the resource provider the authentication token and accesses the resource.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a communications diagram for the LDE authentication system in some embodiments.

FIG. 2 is a block diagram that illustrates components of devices that may be used by the LDE authentication system in some embodiments.

FIG. 3 is a flow diagram that illustrates the overall processing of the LDE authentication system in some embodiments.

FIG. 4 is a flow diagram that illustrates the overall processing of the LDE authentication system when used in a virtual reality conference environment in some embodiments.

### DETAILED DESCRIPTION

A method and system are provided that employ an authentication technique, referred to as an LDE authentication system, to authenticate a user using an LDE device for access to a resource of a resource provider. In some embodiments, the LDE authentication system uses a non-LDE device to authenticate the user. The LDE device then acquires from the non-LDE device authentication information, that is, evidence that the user has been authenticated. The LDE device then provides the authentication information to the resource provider to gain access to the resource. In this way, a user can use a non-LDE device, which provides a user interface that allows for easy entry of information needed to authenticate the user, to assist in authenticating the user so that the LDE device can access a resource provided by the resource provider without having to enter the information via the LDE device.

In some embodiments, when an LDE device used by a user is to access a resource of a resource provider, the LDE device sends to the resource provider a request to access the resource. For example, the LDE device may be a virtual reality headset that is providing a gaming experience via a 3D environment for the user wearing the virtual reality headset. The resource may be, for example, a new module of a game that the user has recently subscribed to, content for a game provided by a third-party resource provider, a contact list of the user that is maintained by a social networking system, a service provided by the resource provider, and so on. The LDE device then receives from the resource provider an indication to authenticate with the resource provider using an identity provider. For example, upon receiving the request, the resource provider may determine that the user has not yet been authenticated and may send to the LDE device an indication that is a uniform resource identifier (“URI”) of a web page provided by the identity provider through which the user can be authenticated using a separate non-LDE device, such as a desktop computer. Alternatively, the user may receiving instructions to authenticate with the identity provider in some other way such as instructions included with a new video game, a label included with a newly purchased headset, and so on.

According to the LDE authentication system, the user then uses a separate device (other than the LDE device) to provide the user's credentials to the identity provider. For example, the user may enter the URI of the web page in a browser of a desktop computer. Alternatively, the LDE device may send the URI of the web page (e.g., via a Bluetooth or other wireless connection) to an application executing on the desktop computer, which directs the browser to display the web page. The user then provides their credentials to the separate device, which forwards the credentials to the identity provider. The credentials may include multiple authentication factors of a multi-factor authentication technique.

After the identity provider authenticates the user, the separate device receives from the identity provider an authentication code. The authentication code is unique to the current authentication. The authentication code also contains authentication information so that when it is presented to the identity provider by a device, the identity provider can associate it with the current authentication of the user. The authentication code may also identify the identity provider. For example, the authentication code may be an encrypted file or a display code such as a Quick Response (“QR”) code, a bar code, and so on. The LDE device then acquires the authentication code from the separate device. For example, the LDE device may acquire the authentication code by an application executing on the separate device transmitting the authentication code via a wireless connection to the LDE device. Alternatively, the separate device may display a QR code, which the LDE device acquires by capturing an image of the QR code.

After the LDE device acquires the authentication code, the LDE device extracts the authentication information from the authentication code and sends the authentication information to the identity provider. The LDE device may extract the identity of the identity provider from the authentication code or may have been configured to access that identity provider. The LDE device then sends the authentication information to the identity provider. In some embodiments, the LDE device may not extract any authentication information but rather may send the entire encrypted file or the image of the QR code to the identity provider. After the identity provider confirms the authentication information, the LDE device receives an authentication token that is sent from the identity provider. The authentication token contains evidence that the identity provider has authenticated the user. The LDE device then sends the authentication token to the resource provider. If the resource provider is satisfied with the evidence of the authentication token, the resource provider allows the LDE device to access the resource.

In some embodiments, the LDE authentication system may be used to allow multiple users using LDE devices access to the same resource. For example, an organization may sponsor a conference in which each of the attendees wears a virtual reality headset. As another example, the users may be team members playing a virtual reality game against another team. To allow the multiple users to access the resource, the LDE device of one of the users sends to the resource provider a request to access the resource. For example, the resource may be a video prepared by the user and stored by a cloud provider, and the user may be a presenter at a conference. As described above, the LDE device then receives an indication sent by the resource provider that the user is to authenticate with the resource provider using an identity provider, the user provides their credentials to a separate device for forwarding to the identity provider, and the separate device receives from the identity provider an authentication code. The separate device then displays the authentication code (e.g., a QR code). The other users then direct their LDE devices to capture an image of the authentication code and retrieve an authentication token from the identity provider as described above. Alternatively, the separate device may wirelessly broadcast the authentication code to the LDE devices. For example, the LDE devices may have been previously registered with the separate device. Each LDE device can then provide the authentication token to the resource provider so that each LDE device can access the resource. In this way, multiple users can gain access to the same resource.

In some embodiments, the LDE authentication system may not use an authentication code. In such a case, the identity provider may provide the authentication token directly in response to receiving the credentials from the separate device and authenticating the user. When the separate device receives the authentication token, it may automatically transmit the authentication token to the LDE device via a wireless connection. When the LDE device receives the authentication token, the LDE device can use the authentication token to gain access to the resource as described above.

Although the LDE authentication system is described primarily with reference to an LDE device that is a visual headset, the LDE authentication system may be used with other types of LDE devices. For example, an LDE device may be a satellite telephone with only a numeric keypad for input. A person renting the satellite phone may want the satellite phone to access a contact list that is stored by a social networking server. In such a case, the user may receive at the user's desktop computer an authentication token from an identity provider. The desktop computer may then wirelessly transmit the authentication code to the satellite phone, which then sends it to the social networking server to gain access to the user's contact list. As another example, the LDE device may be a digital camera with a wireless network connection that needs access to a storage resource for uploading pictures for storage. The digital camera may be used to take a picture of the authentication code. As yet another example, the LDE device may be a fitness monitor device that needs to access a storage resource for uploading fitness information. The fitness monitor device may receive the authentication code via a wireless connection. As another example, the LDE device may be a digital picture frame that needs access to a folder on a server so that it can retrieve digital images to be displayed. The digital picture frame may receive the authentication code via a wireless connection.

In some embodiments, the LDE authentication system may authenticate a user directly with the resource provider without the use of an identity provider. In such a case, the user may provide their credentials directly to the resource provider via a separate device, and the resource provider can provide an authentication code to the separate device. When the LDE device acquires the authentication code from the separate device, it can use the authentication to access the resource. If an LDE device could store a password for the account of the resource provider, then the password would be entered only once (assuming the password did not change). If, however, the resource provider uses a multi-factor authentication, then the additional authentication factor(s) would still need to be provided via the LDE device. Thus, the LDE authentication system can be used so that additional authentication factor(s) can be entered via a non-LDE device.

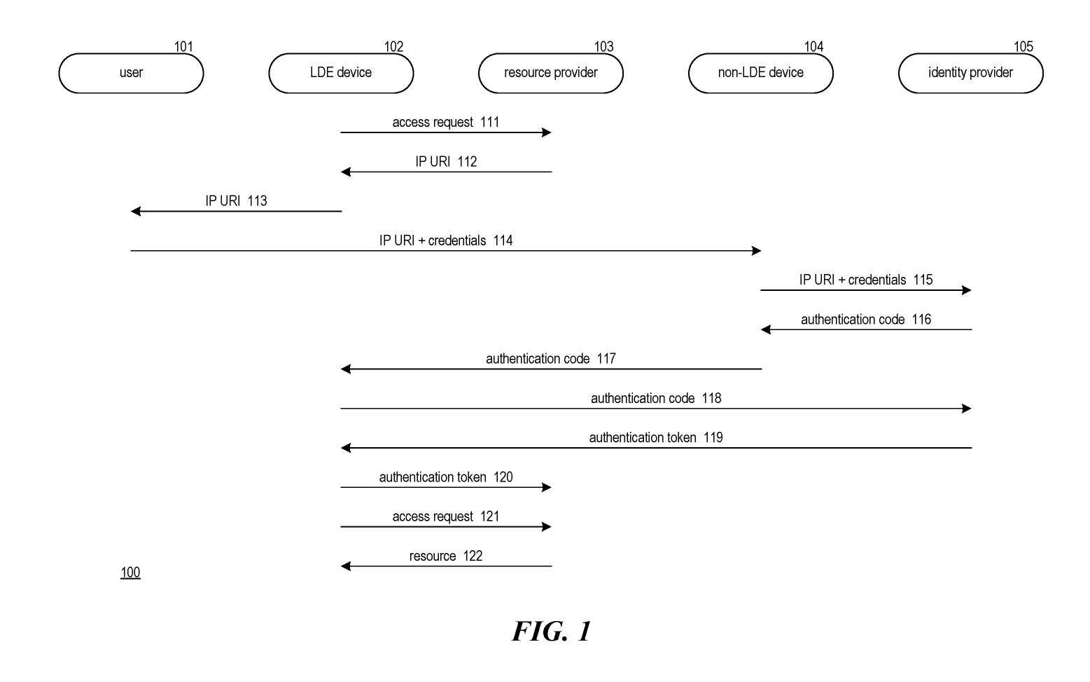

FIG. 1 is a communications diagram for the LDE authentication system in some embodiments. The communications diagram 100 illustrates the communications between a user 101, an LDE device 102, a resource provider 103, a non-LDE device 104, and an identity provider 105. The LDE device sends 111 an access request to the resource provider. The resource provider responds 112 with a URI of an identity provider. The LDE device provides 113 the URI of the identity provider to the user, for example, by displaying the URI along with instructions to authenticate with the identity provider. The user then provides 114 to the non-LDE device the URI of the identity provider and credentials for authenticating with the identity provider. Although shown as one communication, the authentication process may involve multiple communications between the user and the non-LDE device. For example, the user may enter the URI into a browser of the non-LDE device and then enter a password and a one-time code. The non-LDE device then sends 115 the URI and the credentials to the identity provider. After authenticating the user, the identity provider sends 116 the authentication code to the non-LDE device. The non-LDE device then sends 117 the authentication code to the LDE device. Alternatively, the non-LDE device may display the authentication code and the user may direct the LDE device to capture an image of the authentication code. The LDE device then sends 118 the authentication code to the identity provider. The identity provider sends 119 an authentication token to the LDE device. The LDE device forwards 120 the authentication token to the resource provider. The LDE device then sends 121 a request to access the resource to the resource provider. After confirming that the authentication token is indeed evidence of the identity of the user and receiving the request, the resource provider may then send 122 the resource to the LDE device or otherwise grant the LDE device access to the resource.

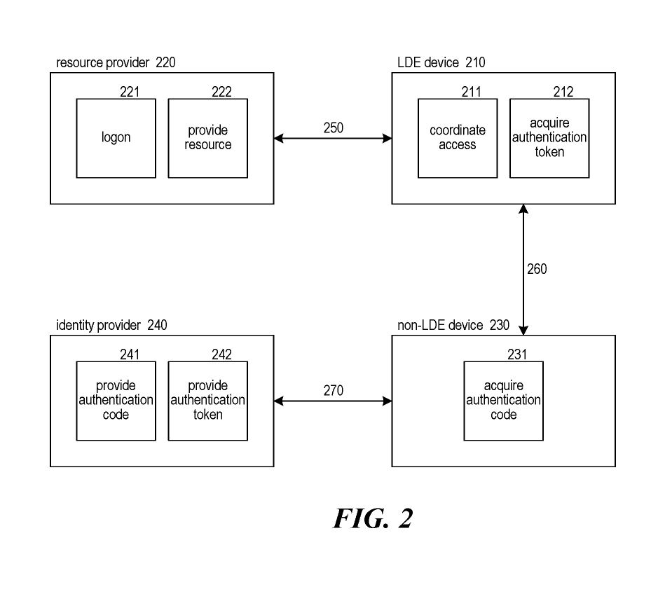

FIG. 2 is a block diagram that illustrates components of devices that may be used by the LDE authentication system in some embodiments. An LDE device 210 may be connected to a resource provider 220 via a communications connection 250 and to a non-LDE device 230 via a communications connection 260. The non-LDE device may be connected to an identity provider 240 via a communications connection 270. The communication connections may be separate connections or a single connection that is shared by the devices. The LDE device includes a coordinate access component 211 and an acquire authentication token component 212. The coordinate access component may coordinate the access to the resource based on communications 111, 112, and 120-122. The acquire authentication token component may coordinate the acquiring of an authentication token based on communications 117-119. The resource provider includes a logon component 221 and a provide resource component 222. The logon component verifies the authentication of the user based on communication 120. The provide resource component provides the LDE device access to the resource based on communications 111, 112, 121, and 122. The non-LDE device includes an acquire authentication code component 231. The acquire authentication code component coordinates the authentication of the user with the identity provider and receives the authentication code based on communications 114-116. The identity provider includes a provide authentication code component 241 and a provide authentication token component 242. The provide authentication code component provides an authentication code to the separate computer based on communications 115 and 116. The provide authentication token component provides an authentication token to the LDE device based on communications 118 and 119.

The computing systems (e.g., LDE device, non-LDE device, identity provider, and resource provider) used by the LDE authentication system may include a central processing unit, input devices, output devices (e.g., display devices and speakers), storage devices (e.g., memory and disk drives), network interfaces, graphics processing units, accelerometers, cellular radio link interfaces, global positioning system devices, and so on. The computing systems may include servers of a data center, massively parallel systems, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the LDE authentication system. The data transmission media are used for transmitting data via transitory, propagating signals or carrier waves (e.g., electromagnetism) via a wired or wireless connection.

The LDE authentication system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the LDE authentication system may be implemented in hardware using, for example, an application-specific integrated circuit (ASIC).

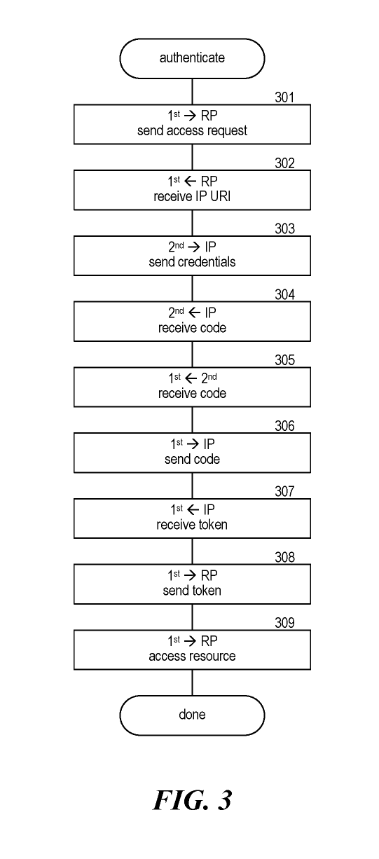

FIG. 3 is a flow diagram that illustrates the overall processing of the LDE authentication system in some embodiments. In block 301, a first device sends an access request to a resource provider. The access request may include the identity of the user and the identity of the resource to be accessed. In block 302, the resource provider, upon determining that the user has not yet been authenticated, sends instructions to the first device for authenticating the user via an identity provider. In block 303, the user provides their credentials to a second device, which forwards the credentials to the identity provider. In block 304, the identity provider, after authenticating the user, sends an authentication code to the second device. In block 305, the first device acquires the authentication code from the second device. In block 306, the first device sends the authentication code to the identity provider. In block 307, the first device receives an authentication token from the identity provider. In block 308, the first device sends the authentication token to the resource provider as evidence of the identity of the user. In block 309, the first device accesses the resource of the resource provider.

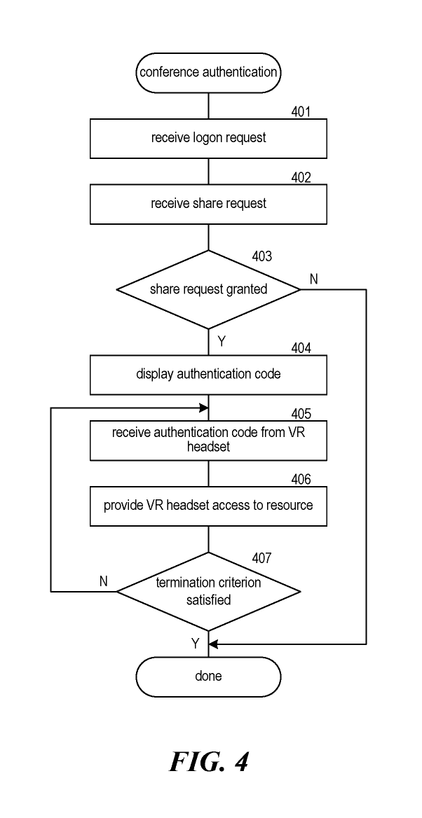

FIG. 4 is a flow diagram that illustrates the overall processing of the LDE authentication system when used in a virtual reality conference environment in some embodiments. In block 401, a resource provider receives a logon request from, for example, a presenter at the conference using a laptop computer. In block 402, the resource provider receives a share request from the presenter to share a resource. In decision block 403, if the share request is granted, then processing continues at block 404, else processing completes. In block 404, an authentication code is displayed on the laptop computer of the presenter. In blocks 405-407, the processing allows multiple attendees of the conference to access the resource. In block 405, the resource provider receives the authentication code from a virtual reality headset of an attendee that was acquired by the headset by capturing an image of the authentication code. In block 406, the resource provider provides the virtual reality headset with access to the resource. In decision block 407, if a termination criterion is satisfied, then the processing completes, else the processing continues at block 405 to receive an authentication code from another virtual reality headset. Alternatively, rather than displaying the authentication code, the laptop computer may transmit the authentication code directly to each virtual reality headset.

The following paragraphs describe various embodiments of aspects of the LDE authentication system. An implementation of the LDE authentication system may employ any combination of the embodiments. The processing described below may be performed by a computing device with a processor that executes computer-executable instructions stored on a computer-readable storage medium that implements the LDE authentication system. A method for accessing a resource of a resource provider is provided. The method accesses instructions to authenticate with the resource provider using an identity provider so that a first device can access the resource. The method sends from a second device to the identity provider credentials for use in authentication. The method receives at the second device an authentication code sent by the identity provider that indicates successful authentication by the identity provider. The method receives at the first device the authentication code that was received by the second device. The method sends from the first device to the identity provider the authentication code. The method receives at the first device an authentication token sent by the identity provider in response to receiving the authentication code. The method sends from the first device to the resource provider the authentication token. The method accesses by the first device the resource of the resource provider. In some embodiments, the first device is a limited data entry device and the second device is a non-limited data entry device. In some embodiments, the first device is a virtual reality headset. In some embodiments, the resource is accessed by a virtual reality application executing on the first device. In some embodiments, the sending of credentials is part of a multi-factor authentication. In some embodiments, the authentication code is a display code and the receiving at the first device of the authentication code includes capturing by the first device an image of the display code that is displayed by the second device. In some embodiments, the method further sends from the second device the authentication code to the first device. In some embodiments, the second device sends the authentication code to the first device via a wireless communications technique. In some embodiments, the resource provider sends a uniform resource identifier of the identity provider along with the indication to authenticate. In some embodiments, the accessing of the instructions to authenticate includes sending from the first device to the resource provider a request to access the resource and receiving at the first device an indication sent by the resource provider to authenticate with the resource provider using the identity provider.

In some embodiments, a method for accessing a resource of a resource provider for use in a 3D environment is provided. The method sends from a visual headset worn by a user to the resource provider a request to access the resource. The method receives at the visual headset an indication sent by the resource provider that the user is to authenticate with the resource provider using an identity provider. The method sends from a device, other than the visual headset, to the identity provider credentials for use in authentication of the user via a multi-factor authentication. The method receives at the device an authentication token sent by the identity provider that can be used as evidence of the identity of the user. The method sends from the device to the visual headset the authentication token. The method receives at the visual headset the authentication token sent by the device. The method sends from the visual headset to the resource provider the authentication token. The method accesses by the visual headset the resource of the resource provider. In some embodiments, the resource provider sends a uniform resource identifier of the identity provider along with the indication to authenticate.

In some embodiments, a method performed by a computing system for facilitating access to a resource of a sharing participant during a conference conducted in a 3D environment with participants wearing visual headsets is provided. The method receives from the sharing participant via a device, other than a visual headset, logon information and a request to share the resource. When the sharing participant is authenticated based on the logon information, the method sends to the device an authentication code for display on the device. For each of a plurality of visual headsets of multiple participants in the conference, the method receives from the visual headset the authentication code, which was collected by the visual headset by capturing an image of the displayed authentication code. In response to receiving the authentication code from the visual headset, the method provides visual headset with access to the resource. In some embodiments, the authentication code is a display code. In some embodiments, the resource is a document that is displayed by the visual headsets.

In some embodiments, a visual headset for accessing a resource of a resource provider is provided. The visual headset includes a computer-readable storage medium storing computer-executable instructions and a processor for executing the computer-executable instructions stored in the computer-readable storage medium. The computer-executable instructions for controlling the visual headset to receive an authentication code provided by an identity provider to a device other than the visual headset, the authentication code provided to the device in response to a user requesting that the identity provider provide the authentication code to the device based on information provided by the resource provider. The instructions for further controlling the visual headset to send to the identity provider the authentication code. The instructions for further controlling the visual headset to receive from the identity provider an authentication token sent by the identity provider in response to receiving the authentication code. The instructions for further controlling the visual headset to send to the resource provider the authentication token. The instructions for further controlling the visual headset to access the resource of the resource provider. In some embodiments, the authentication code is a display code and the instructions that receive the authentication code include instructions that capture an image of the display code that is displayed by a device. In some embodiments, the computer-executable instructions further control the visual headset to send to the resource provider a request to access the resource, receive from the resource provider a uniform resource identifier of the identity provider that is to authenticate the user of the visual headset, and provide the uniform resource identifier to the user so that the user can request the identity provider to provide the authentication code. In some embodiments, the authentication code is sent to the visual headset via a wireless communications technique.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method for accessing a resource of a resource provider, the method comprising:
accessing instructions to authenticate with the resource provider using an identity provider so that a first device can access the resource;
sending from a second device to the identity provider credentials for use in authentication;
receiving at the second device an authentication code sent by the identity provider that indicates successful authentication by the identity provider;
receiving at the first device the authentication code that was received by the second device;
sending from the first device to the identity provider the authentication code;
receiving at the first device an authentication token sent by the identity provider in response to receiving the authentication code;
sending from the first device to the resource provider the authentication token; and
accessing by the first device the resource of the resource provider.

2. The method of claim 1 wherein the first device is a limited data entry device and the second device is a non-limited data entry device.

3. The method of claim 2 wherein the first device is a virtual reality headset.

4. The method of claim 1 wherein the resource is accessed by a virtual reality application executing on the first device.

5. The method of claim 1 wherein the sending of credentials is part of a multi-factor authentication.

6. The method of claim 1 wherein the authentication code is a display code and the receiving at the first device of the authentication code includes capturing by the first device an image of the display code that is displayed by the second device.

7. The method of claim 1 wherein the display code is a bar code.

8. The method of claim 1 further comprising sending from the second device the authentication code to the first device.

9. The method of claim 8 wherein the second device sends the authentication code to the first device via a wireless communications technique.

10. The method of claim 1 wherein the resource provider sends a uniform resource identifier of the identity provider along with the indication to authenticate.

11. The method of claim 1 wherein the accessing of the instructions to authenticate includes:
sending from the first device to the resource provider a request to access the resource; and
receiving at the first device an indication sent by the resource provider to authenticate with the resource provider using the identity provider.

12. A method for accessing a resource of a resource provider for use in a 3D environment, the method comprising:
sending from a visual headset worn by a user to the resource provider a request to access the resource;
receiving at the visual headset an indication sent by the resource provider that the user is to authenticate with the resource provider using an identity provider;
sending from a device, other than the visual headset, to the identity provider credentials for use in authentication of the user via a multi-factor authentication;
receiving at the device an authentication token sent by the identity provider that can be used as evidence of the identity of the user;
sending from the device to the visual headset the authentication token;
receiving at the visual headset the authentication token sent by the device;
sending from the visual headset to the resource provider the authentication token; and
accessing by the visual headset the resource of the resource provider.

13. The method of claim 11 wherein the resource provider sends a uniform resource identifier of the identity provider along with the indication to authenticate.

14. A method performed by a computing system for facilitating access to a resource of a sharing participant during a conference conducted in a 3D environment with participants wearing visual headsets, the method comprising:
receiving from the sharing participant via a device, other than a visual headset, logon information and a request to share the resource;
when the sharing participant is authenticated based on the logon information, sending to the device an authentication code for display on the device; and
for each of a plurality of visual headsets of multiple participants in the conference,
receiving from the visual headset the authentication code, which was collected by the visual headset by capturing an image of the displayed authentication code; and
in response to receiving the authentication code from the visual headset, providing the visual headset with access to the resource.

15. The method of claim 14 wherein the authentication code is a display code.

16. The method of claim 14 wherein the resource is a document that is displayed by the visual headsets.

17. A visual headset for accessing a resource of a resource provider, comprising:
a computer-readable storage medium storing computer-executable instructions for controlling the visual headset to:
receive an authentication code provided by an identity provider to a device other than the visual headset, the authentication code provided to the device in response to a user requesting that the identity provider provide the authentication code to the device based on information provided by the resource provider;
send to the identity provider the authentication code;
receive from the identity provider an authentication token sent by the identity provider in response to receiving the authentication code;
send to the resource provider the authentication token; and
access the resource of the resource provider; and
a processor that executes the computer-executable instructions stored in the computer-readable storage medium.

18. The visual headset of claim 17 wherein the authentication code is a display code and the instructions that receive the authentication code include instructions that capture an image of the display code that is displayed by a device.

19. The visual headset of claim 17 wherein the computer-executable instructions further control the visual headset to:
send to the resource provider a request to access the resource;
receive from the resource provider a uniform resource identifier of the identity provider that is to authenticate the user of the visual headset; and
provide the uniform resource identifier to the user so that the user can request the identity provider to provide the authentication code.

20. The visual headset of claim 17 wherein the authentication code is sent to the visual headset via a wireless communications technique.

21. A computing system for allowing access to a resource, the computing system comprising:
a computer-readable storage medium storing computer-executable instructions for controlling the computing system to:
receive from a first device a request to access the resource;
direct a user of the first device to authenticate with an identity provider using a second device;
receive from the first device an authentication token sent by the identity provider to the second device based on the user authenticating with the identity provider; and
after the authentication token is received by the computing system, allow the first device to access the resource; and
a processor for executing the computer-executable instruction stored in the computer-readable storage medium.

22. The computing system of claim 21 wherein the second device sends credentials of the user to the identify provider, receives the authentication token from the identity provider and the first device receives the authentication token.

23. The computing system of claim 22 wherein the second device transmits the authentication token to the first device.

24. The computing system of claim 22 wherein the second device outputs the authentication token to the user and the first device receives the authentication token from the user.

25. The computing system of claim 21 wherein the first device is a limited data entry device and the second device is not a limited data entry device.

26. A computing system for allowing access to a resource, the computing system comprising:
a computer-readable storage medium storing computer-executable instructions for controlling the computing system to:
receive from a first device an authentication token sent by an identity provider to a second device based on a user authenticating with the identity provider wherein the authentication token that is sent to the second device is received by the first device; and
after receiving the authentication token, allow the first device to access the resource; and
a processor for executing the computer-executable instruction stored in the computer-readable storage medium.

27. The computing system of claim 26 wherein the second device sends credentials of the user to the identify provider and receives the authentication token from the identity provider and the first device receives the authentication token.

28. The computing system of claim 27 wherein the second device transmits the authentication token to the first device.

29. The computing system of claim 27 wherein the second device outputs the authentication token and the first device receives the authentication token from the user.

30. The computing system of claim 26 wherein the first device is a limited data entry device and the second device is not a limited data entry device.
